(19) United States
(12) Patent Application Publication
(10) Pub. No.: US 2005/0207289 A1
(43) Pub. Date: Sep. 22, 2005

(54) MULTIMEDIA DISK BOX

(76) Inventor: Chin-Yao Chang, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,537

(22) Filed: Mar. 10, 2004

(51) Int. Cl. G11B 7/085

(52) U.S. Cl. 369/30.06

(57) ABSTRACT

A multimedia disk box has a housing and a chip used to input, output, and save a signal such as speech or multimedia data. In addition to the function of holding a multimedia disk, the multi-media disk box provides other functions of added value, including recording, playing, and providing encryption/decryption.

### BACKGROUND OF INVENTION

1. Field of the Invention

The present invention relates to a multimedia disk box, and more particularly, to a multimedia disk box with a chip.

2. Description of the Prior Art

With development of multimedia processing technology, digital multimedia provides users with access to widespread applications. For example, Compact Disks (CDs), Video Compact Disks (VCDs), and Digital Video/Versatile Disks (DVDs) are used to record and store music, software, images, and video. Digital versatile disks have multiple formats such as SACD, DVD-Audio, DVD-Video, DVD-ROM (Read Only Memory), DVD-RAM (Random Access Memory), and DVD-R. Multimedia disks not only reduce physical storage space for selling disks effectively but also allow users to exchange and enjoy plentiful audiovisual information conveniently. Many companies design all kinds of multimedia disk boxes to appeal to consumers, and such designs typically address the style, the structure and the capacity of a box.

Please refer to FIG. 1. FIG. 1 shows a diagram of a prior art multimedia disk box 10. The multimedia disk box 10 comprises a recess 12 for holding a multimedia disk 18. However, the multimedia disk box 10 only serves the functions of storage and disk preservation, and does not provide other functions of added value. In addition, the proliferation of recording devices intensifies the problems of multimedia copyright. Thus, how to develop an effective mechanism to manage information and protect copyright is a most important issue.

### SUMMARY OF INVENTION

It is therefore a primary objective of the claimed invention to provide a multimedia disk box with a chip.

According to the claimed invention, a multimedia disk box comprises a housing, which comprises a recess for holding at least a multimedia disk, and a chip in the multimedia disk box for storing and outputting a signal.

It is an advantage of the claimed invention that the multimedia disk box has a chip that can provide functions of added value. For example, the chip can store music, speech, or other multimedia data for disk introduction or personalized applications. In addition, the chip also can be used to store signals for encryption/decryption.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior art multimedia disk box.

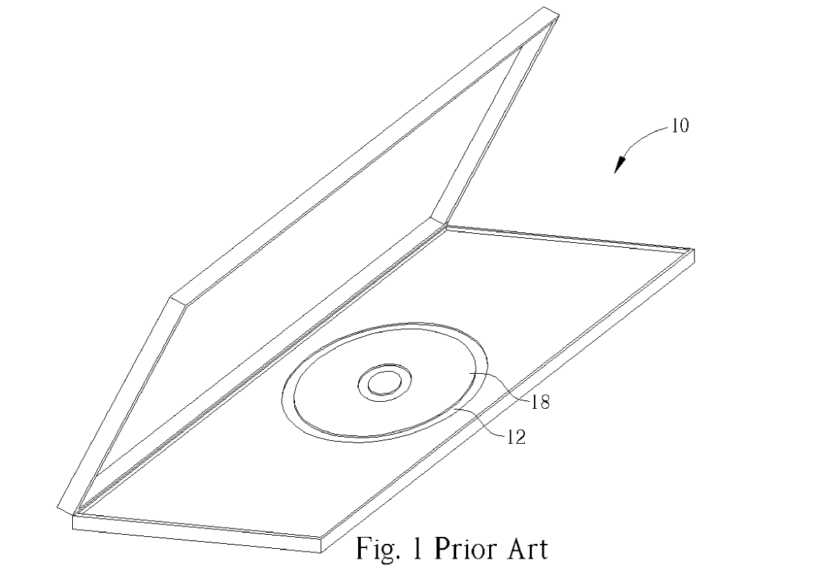

FIG. 2 is a diagram of a multimedia disk box according to the present invention.

FIG. 3 is a diagram of a DVD box according to the present invention.

FIG. 4 is a functional diagram of a chip of the multimedia disk box and the DVD box according to the present invention.

### DETAILED DESCRIPTION

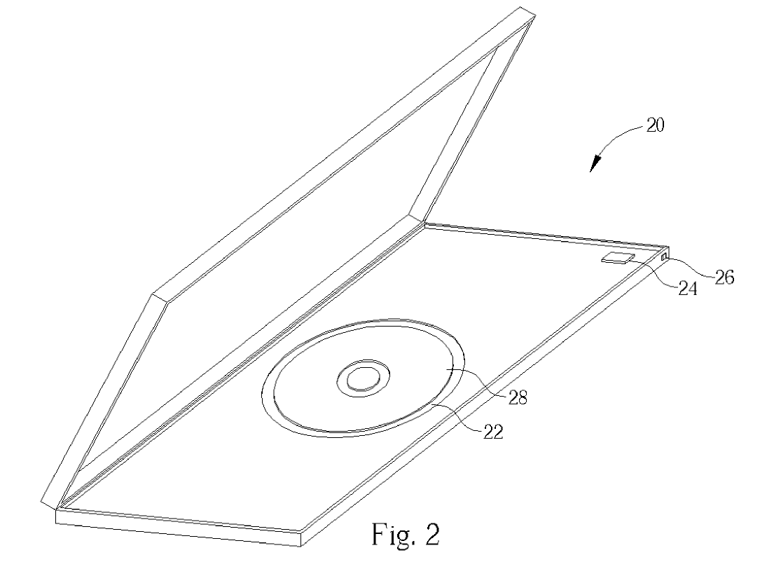

Please refer to FIG. 2. FIG. 2 shows a diagram of a multimedia disk box 20 according to the present invention. The multimedia disk box 20 comprises a recess 22, a chip 24, and an input control switch 26. The multimedia disk box 20 is made of plastic (such as acrylic), cardboard, or other suitable material. The recess 22 is used to hold a CD or DVD 28. The cover of the multimedia disk box 20 covers the recess 22 by way of a mechanism such as pasting, wrapping, or clipping. The cover of the multimedia disk box 20 also can be connected to the recess 22. The chip 24 is embedded or pasted at some position on or in the multimedia disk box 20 for providing users or sales outlets added value functions. The input control switch 26 controls the functions of input and output. The chip 24 can receive and store a signal when the input control switch 26 is turned on, while the chip 24 can output the stored signal when the input control switch 26 is turned off.

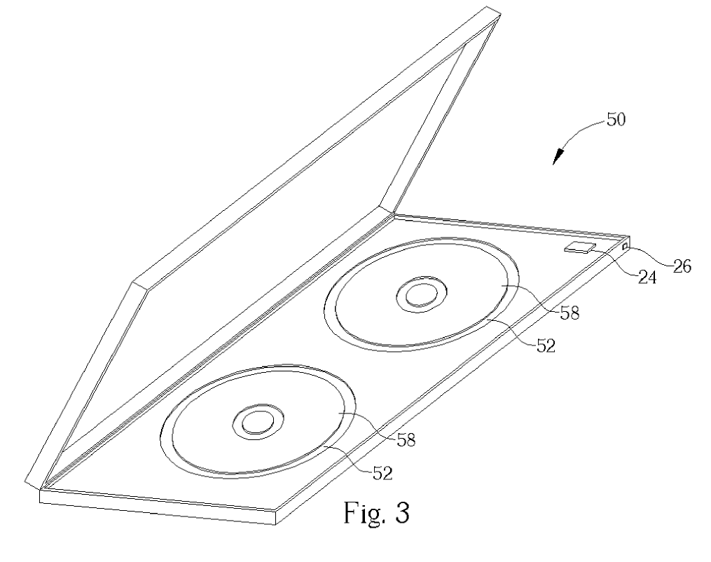

Please refer to FIG. 3. FIG. 3 shows a diagram of a dual-disk DVD box 50 according to the present invention. The DVD box 50 comprises two recesses 52, the chip 24, and the input control switch 26. The DVD box is made of plastic (such as acrylic), cardboard, or other suitable material. The recesses 52 are used to hold DVDs 58. The cover of the DVD box 50 covers the recesses 52 by way of a mechanism such as pasting, wrapping, or clipping. The cover of the DVD box 50 also can be connected to the recess 52. The chip 24 is embedded or pasted at some position on or in the DVD box 50 for providing users or sales outlets added value functions. The input control switch 26 controls the functions of input and output. The chip 24 can receive and store a signal when the input control switch 26 is turned on, while the chip 24 can output the stored signal when the input control switch 26 is turned off.

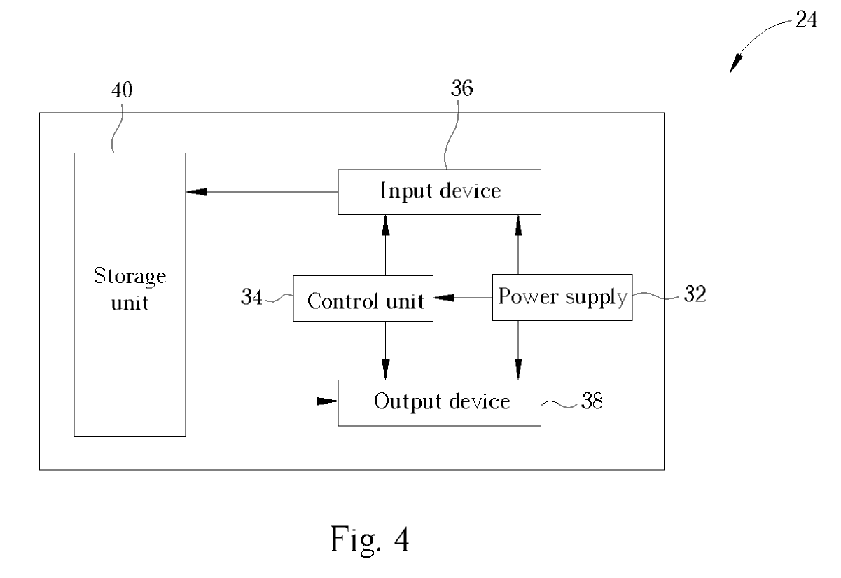

Please refer to FIG. 4. FIG. 4 shows a functional diagram of the chip 24 of the multimedia disk box 20 and the DVD box 50. The chip 24 comprises a power supply 32, a control unit 34, an input device 36, an output device 38, and a storage unit 40. The power supply 32 is electrically connected to the control unit 34, the input device 36, and the output device 38. The control unit 34 is electrically connected to the input device 36 and the output device 38. The input device 36 and the output device 38 are electrically connected to the storage unit 40. The power supply 32 may be a Li-type battery, a light-activated battery, a power converter, or similar device for providing a specified power to the control unit 34, the input device 36, and the output device 38. The control unit 34 is further electrically connected to the input control switch 26 shown in FIG. 2 and FIG. 3 for switching and controlling all functions of the chip 24. The control unit 34 controls the input device 36 to receive a signal and store the signal in the storage unit 40, and controls the output device 38 to output the stored signal. In other words, the control unit 34 transmits an input instruction to the input device 36 when a signal is inputted, which makes the input device 36 receive the signal and the storage unit 40 store the signal. The control unit 34 transmits an output instruction to the output device 38 when a signal is outputted, which makes the output device 38 output the signal stored in the storage unit 40.

The input device 36 is a signal port or a recorder for receiving a signal, speech data, or multimedia data. The output device 38 is a signal port or a player for outputting the signal, speech data, or multimedia data stored in the storage unit 40. In the examples of present invention, the storage unit 40 can be a Read Only Memory (ROM), an Erasable Programmable ROM (EPROM), an Electrically Erasable Programmable ROM (EEPROM), or a Flash ROM. If the storage unit 40 is ROM, users can not input any data and the input control switch 26 as well as the input device 36 can be removed. The data stored in the storage unit 40 can be written by a manufacturer for introducing the content of the multimedia disks. If the storage unit 40 is a flash ROM, users can switch the input control switch 26 to input data. In addition, the storage unit 40 can record the name, price, manufacturing date, or other data of the multimedia disk an can be used to replace a Universal Product Code (UPC). The storage unit 40 can save specified passwords to deal with problems of copyright by an encryption/decryption operation. As a result, the present invention multimedia disk box provides added value functions.

Those skilled in the art will readily observe that numerous modifications and alterations of the device may be made while retaining the teachings of the invention. Accordingly, that above disclosure should be construed as limited only by the metes and bounds of the appended claims.

1. A multimedia disk box comprising:
a housing, comprising a recess for holding at least a multimedia disk; and
a chip in the multimedia disk box for storing and outputting a signal.

2. The multimedia disk box of claim 1 wherein the housing further comprises a cover for covering the recess.

3. The multimedia disk box of claim 1 wherein the chip is embedded in the housing.

4. The multimedia disk box of claim 1 wherein the chip comprises:
a storage unit for storing the signal; and
an output device electrically connected with the storage unit for outputting the signal stored in the storage unit.

5. The multimedia disk box of claim 4 wherein the storage unit comprises a Read Only Memory (ROM), an Erasable Programmable ROM (EPROM), an Electrically Erasable Programmable ROM (EEPROM), or a Flash ROM.

6. The multimedia disk box of claim 4 wherein the signal comprises multimedia, digital data, passwords of encryption/decryption, or programs.

7. The multimedia disk box of claim 4 wherein the output device is a signal port for outputting the signal serially.

8. The multimedia disk box of claim 4 wherein the output device is a player for playing the signal.

9. The multimedia disk box of claim 4 wherein the chip further comprises a power supply for providing power required by the chip.

10. The multimedia disk box of claim 9 wherein the power supply comprises a power converter for converting a power into a specified power required by the chip.

11. The multimedia disk box of claim 9 wherein the chip further comprises an input device electrically connected to the power supply and the storage unit for receiving a signal sent to the chip.

12. The multimedia disk box of claim 11 wherein the housing further comprises an input control switch electrically connected to the input device for controlling the signal to input.

13. The multimedia disk box of claim 12 wherein the chip further comprises a control unit electrically connected to the power supply, the input device, and the output device for controlling the functions of the chip, the control unit transmitting an input instruction to the input device to receive and store the signal, the control unit transmitting an output instruction to the output device to output the stored signal.

14. The multimedia disk box of claim 1 wherein the multimedia disk is a Compact Disk (CD).

15. The multimedia disk box of claim 1 wherein the multimedia disk is a Digital Video Disk (DVD).

16. A compact disk (CD) box comprising:
a housing comprising a recess for holding at least a CD; and
a chip in the CD box for storing and outputting a signal.

17. The CD box of claim 16 wherein the housing further comprises a cover for covering the recess.

18. The CD box of claim 16 wherein the chip is embedded in the housing.

19. The CD box of claim 16 wherein the chip comprises:
a storage unit for storing the signal; and
an output device electrically connected with the storage unit for outputting the signal of the storage unit.

20. The CD box of claim 19 wherein the storage unit comprises a Read Only Memory (ROM), an Erasable Programmable ROM (EPROM), an Electrically Erasable Programmable ROM (EEPROM), or a Flash ROM.

21. The CD box of claim 19 wherein the signal comprises multimedia, digital data, passwords of encryption/decryption, or programs.

22. The CD box of claim 19 wherein the output device is a player for playing the signal.

23. The CD box of claim 19 wherein the chip further comprises a power supply for providing power required by the chip.

24. The CD box of claim 23 wherein the chip further comprises an input device electrically connected to the power supply and the storage unit for receiving a signal sent to the chip.

25. The CD box of claim 24 wherein the housing further comprises an input control switch electrically connected to the input device for controlling the signal to input.

26. The CD box of claim 25 wherein the chip further comprises a control unit electrically connected to the power supply, the input device, and the output device for controlling the functions of the chip, the control unit transmitting an input instruction to the input device to receive and store the signal, the control unit transmitting an output instruction to the output device to output the stored signal.
